(19) United States
(12) Patent Application Publication
(10) Pub. No.: US 2025/0389161 A1
(43) Pub. Date: Dec. 25, 2025

(54) Coupled Connection for Drilling-With-Casing Operations and Tight Clearance Casing Strings in Oil and Gas Wells

(71) Applicant: GB Connections LLC, Houston, TX (US)

(72) Inventor: Eugene J. MANNELLA, Houston, TX (US)

(21) Appl. No.: 19/017,592

(22) Filed: Jan. 11, 2025

Related U.S. Application Data
(60) Provisional application No. 63/661,766, filed on Jun. 19, 2024.

(51) Int. Cl. E21B 17/042; F16L 15/00

(52) U.S. Cl. CPC E21B 17/042; F16L 15/002

(57) ABSTRACT

A tubular system joins tubulars using couplings, which includes continuous internal thread having sections converging and diverging at different angles. A first section's diameter converges linearly inward at a steep angle to a first intersection, a second section converges linearly at a less steep angle from the first intersection to a second intersection, and a third section diverges linearly outward at another angle from the second section. Tangential curvatures at the intersections enhance the coupling's efficiency and fit.

### CROSS-REFERENCE TO RELATED APPLICATIONS

This application claims the benefit of U.S. Provisional Appl. No. 63/661,766 filed Jun. 19, 2024, which is incorporated herein by reference in its entirety.

### FIELD OF THE DISCLOSURE

The subject matter of the present disclosure relates generally to threaded connections for joining together tubulars used in oil and gas well exploration and production. More particularly, it relates to couplings for joining individual lengths of casing used in wellbores.

### BACKGROUND OF THE DISCLOSURE

Conventional drilling methods to drill an oil and gas well use drill pipe specifically designed for and dedicated to drilling the wellbore. Traditionally, drilling the wellbore involves using a drill bit attached to a drill string to cut through the earth. As the wellbore advances, new sections are drilled with successively smaller drill bits, and the new sections are sealed off with smaller strings of casing until a target depth is achieved. A full casing program consists of multiple telescoping strings of casing, which are cemented in place. After drilling the wellbore, the drill pipe can be transported to another wellsite to drill another well and can be used until it is worn out.

In contrast to the above procedure, casing can be used for both drilling the well and casing off the open hole. The procedure is commonly referred to as “Drilling With Casing” (DWC) or “Casing while Drilling” (CwD). In this method, the casing itself is used as the drill string and has a drill bit attached to its bottom end. Two types of drill bits are commonly used in drilling with casing operations. One is a retrievable bit, and the other is expendable, is drilled out, and is left behind. Drilling with casing can reduce drilling costs, streamline the drilling process, enhance wellbore stability, and reduce the risks associated with conventional drilling methods.

In one advantage, for example, drilling with casing can improve wellbore stability. In traditional drilling, the drilled hole remains exposed for a period before the casing is installed, which can lead to wellbore instability, especially in formations prone to collapse or in high-pressure environments. By using the casing as the drill string, the wellbore is cased immediately as it is drilled, significantly reducing the risk of wellbore collapse. As such, drilling with casing makes it possible to penetrate trouble zones successfully, which may not be possible using “conventional” methods. This immediate casing also minimizes the loss of drilling fluids and reduces the risk of formation damage, which can occur when fluids interact with the formation.

In another advantage, drilling with casing reduces the time required to drill and complete a well. In conventional drilling, the process of drilling, withdrawing the drill string, and then running the casing into the well can be time-consuming. By combining these steps into a single operation, drilling with casing streamlines the entire process, leading to faster well completion times. This efficiency is particularly beneficial in complex drilling environments, such as in deepwater or unconventional reservoirs, where drilling risks and costs are higher.

Environmental and safety aspects are also improved with drilling with casing. The reduced exposure time of the wellbore means there is less chance of blowouts, one of the most significant risks in drilling operations. This reduction in risk contributes to a safer working environment for the rig crew. Additionally, since there is less handling of drilling fluids and cuttings, there is a decreased environmental footprint. Finally, drilling with casing can also reduce the number of trips in and out of the well, leading to lower emissions and less wear and tear on drilling equipment.

In conventional casing usage, the casing and its connections are subjected only to static loads consisting of tension, compression, bending, pressure (internal and external), and any combination thereof. In drilling with casing usage, the casing and connections are not only subject to all of the listed static loads, but they are also subject to cyclic, dynamic loads such as vibration, slip-stick, rotational bending due to rotating the casing and advancement downhole while drilling the wellbore. For example, the casing can be rotated at rotational speeds ranging on the conservative side from about 30 to 120 RPM (revolutions per minute) for drilling operations and 15 to about 40 RPM for advancement to target operations and during cementing operations after the string is fully deployed. Of course, the rotational speed for the casing can vary depending on the implementation, the type of formation being drilled, the casing diameter, the casing material, specific drilling conditions, drilling fluids, bit type, etc. In general, the rotational speeds for the casing would tend to be lower compared to conventional drilling because rotating the casing at higher speeds can cause wear and fatigue, potentially leading to failure of the casing.

As the casing rotates and advances down the wellbore the casing string is subject to cyclic fatigue loads. For example, the couplings have a larger outside diameter than the casing and contact the wellbore wall, which causes side impacts and abrasion to the outside diameter surface. With enough wear, the coupling outside diameter will erode reducing the coupling wall thickness. Under certain circumstances, this can lead to a failure in the coupling. Connections deployed for drilling with casing or rotating to achieve target are also known to fail in the pin member a few threads inside the coupling bearing face. This is the area of flexure that experiences the highest stress reversals during rotating operations. Employing the taper change in the prior art reduces bearing stress between the coupling thread crest and the pin tread root. This reduction in bearing stress greatly enhances the fatigue life of the connection. Then, once the casing is set and cemented in the well, dynamic loads cease, and the casing remains subject to all the static loads mentioned above.

Experience to date with drilling with casing has demonstrated a need for a more robust, yet economical casing connection to withstand the additional rigors of dynamic loading and frictional wear caused by rotating the casing string while drilling or by rotating the string for target achievement. One solution in the prior art is disclosed in U.S. Pat. Nos. 7,347,459 and 8,075,023 by the same inventor.

For example, FIG. 1A illustrates a side view, partially in cross-section, of two tubular sections 10a-b joined using a prior art coupling 20 according to the prior art, and FIG. 1B illustrates a side view, partially in cross-section, of two tubular sections 10a-b joined using an alternative coupling 20 of the prior art. Both prior art couplings 20 have internal threads 22a-b that thread to external threads 12a-b on the pins of the tubular sections 10a-b. The prior art coupling 20 in FIG. 1B has an internal, center reinforcing cross-section or ring 27, while the prior art coupling 20 in FIG. 1A does not. The coupling 20 is machined from a single blank, which is cut from a heavy-wall steel tube known in the industry as coupling stock.

The internal coupling threads 22a-b have multiple tapered sections (S1, S2, S3). The transition from one taper section (S1, S2, S3) to another uses a simple intersection of the straight-line tapers. In this prior art coupling 20, the multiple taper sections (S1, S2, S3) are provided to reduce circumferential hoop stresses and soften the resulting longitudinal hoop stress distribution through thinner cross-sections of both the coupling 20 and the pin of the pipes 10a-b. This has been achieved by reducing the coupling cross-section relative to the pin cross-section, which reduces localized thread interference and the possibility of thread galling during connection assembly.

Nevertheless, new drilling technologies and advancements in drilling operations have allowed operators to drill wells with significantly longer lateral sections, which may exceed 22,000 ft (4 miles) in some formations. And every year, operators work to achieve even longer lateral sections. With every increase in lateral length beyond about 12,000 to 15,000 ft, the challenges of successful casing deployment increase exponentially. While drilling with casing is still a viable process, it is less common compared to the process of rotating casing to achieve a target depth in long lateral wells. In this process, initial sections of the well are drilled using a conventional drill string, which can be rotated and steered to follow the planned path. This includes drilling down to the kickoff point where the well begins to deviate from vertical.

After reaching a predetermined depth, developing the curved and lateral sections of the wellbore, casing is then run into the well. Casing running tools (CRT) used at the rig can both rotate and reciprocate the casing as it is run into the hole. The rotation reduces friction, which is particularly effective in long lateral wells where reaching extended depths are hindered by increased friction and complexity of advancing along the irregular wellbore.

For example, many of today's wells are directional with a vertical section, a curved section, and then a long horizontal lateral. Lateral sections in contemporary wells are typically 5,000 to 12,000 ft. Although, so-called, super-lateral wells have been drilled with 22,000 ft (4 mile) horizontal sections. Once the drill string is pulled from the open hole, casing is deployed by making up individual lengths of casing and lowering them into the open hole. Getting the casing down into the well, around the curved section, and out to the end of a long lateral section is often difficult. To assist casing deployment, operators may have to reciprocate (push and pull) and/or rotate the casing to assist advancement to the end of the long lateral section. Working casing strings in this manner to achieve target depths or to free stuck pipe imparts significant variable load combinations that are cyclic in nature that can potentially cause early and unexpected failure of connections by fatigue, helical buckling, and other failure mechanisms.

Although existing casing connections may be useful and beneficial, ever-increasing demands are being placed on casing connections used in drilling with casing operations and/or rotating casing to aid target achievement to meet the new drilling technology demands, and difficulties with casing advancement in drilling operations. Moreover, standard American Petroleum Institute (API) threaded connections have a very loose tolerance requirement. For example, the allowable make-up variation is 0.575 inches (i.e., 2.88 turns) between the minimum and maximum make-up positions. For these reasons, the subject matter of the present disclosure is directed to addressing issues associated with drilling with casing, rotating to achieve the target landing location in the well and particularly to addressing the connections used to join each length of casing together.

The subject matter of the present disclosure is directed to overcoming, or at least reducing the effects of, one or more of the problems set forth above.

### SUMMARY OF THE DISCLOSURE

In one configuration, a coupling is used for joining tubulars. The coupling comprises a body having a first end and a second end and defining a bore therethrough. At least a first portion of the bore defines a first continuous internal thread, which has a first section, a second section, and a third section. The first section is disposed toward the first end, the second section is connected with the first section at a first intersection, and the third section connected with the second section at a second intersection.

An internal diameter of the first continuous internal thread for the first section converges linearly inward toward the bore at a first angle from a first point to the first intersection. The internal diameter for the second section converges linearly inward toward the bore at a second angle from the first intersection to the second intersection. The second angle is less than the first angle. Finally, the internal diameter for the third section diverges linearly outward from the bore at a third angle from the second intersection to a second point. The internal diameter of the first continuous internal thread defines at least one of: (i) a first curvature transitioning between the first and second angles at the first intersection of the first and second sections, and (ii) a second curvature transitioning between the second and third angles at the second intersection of the second and third sections. In one arrangement, the first curvature is tangential to the first and second angles, and/or the second curvature is tangential to the second and third angles.

In another configuration of the present disclosure, a tubular system comprises a plurality of tubulars and a plurality of couplings. Each of the tubulars has a pipe body with a first outer diameter and defines a first bore with an inner diameter. Each of the tubulars has pins disposed on ends of the tubular, and the pins have external thread. The couplings are configured to join the tubulars together and are configured as described above.

The foregoing summary is not intended to summarize each potential embodiment or every aspect of the present disclosure.

### BRIEF DESCRIPTION OF THE DRAWINGS

FIG. 1A illustrates a side view, partially in cross-section, of two pipes joined using a coupling according to the prior art.

FIG. 1B illustrates a side view, partially in cross-section, of two pipes joined using an alternative coupling of the prior art.

FIG. 2A illustrates a cross-sectional view of a connection assembly according to the present disclosure joining two tubulars together.

FIG. 2B illustrates a cross-sectional view of another connection assembly according to the present disclosure joining two tubulars together.

FIG. 3A illustrates a side view, in partial cross-section, of the connection assembly of FIG. 2A, further including an unthreaded extension.

FIG. 3B illustrates a side view, in partial cross-section, of the connection assembly of FIG. 2B, further including an unthreaded extension.

FIG. 4A illustrates a schematic of continuous internal thread (not to scale) having three sections with adjacent sections intersecting at a point according to the present disclosure.

FIG. 4B illustrates another schematic of the continuous internal thread (not to scale) having three sections where each section transitions to the adjacent section through a tangential curve according to the present disclosure.

FIGS. 5A-5B schematically illustrate generic first and second types of tooling for making a thread form.

FIG. 6A schematically illustrates a representation of a helical profile for two tapered sections meeting at an intersection according to the prior art.

FIG. 6B schematically illustrates a cross-section of the representation in FIG. 6A.

FIG. 7A schematically illustrates a representation of a helical profile for two tapered sections meeting at a tangentially curved transition according to the present disclosure.

FIG. 7B schematically illustrates a cross-section of the representation in FIG. 7A.

FIG. 8A illustrates a schematic analysis of force during mill makeup of the prior art coupling to the “mill end” of a tubular.

FIG. 8B illustrates a schematic analysis of force during field makeup of the “field end” of another tubular to the prior art coupling.

FIG. 9A illustrates a schematic analysis of force caused by mill makeup of the disclosed coupling to the “mill end” of a tubular.

FIG. 9B illustrates a schematic analysis of force caused field makeup of the “field end” of another tubular to the disclosed coupling.

FIG. 10A illustrates a cross-sectional view of another connection assembly according to the present disclosure, joining two tubulars together with a coupling.

FIG. 10B illustrates a cross-sectional view of yet another connection assembly according to the present disclosure, joining two tubulars together with a coupling.

FIG. 11 illustrates a cross-sectional view of a connection assembly according to the present disclosure for joining two tubulars together with a coupling in a slim hole coupled connection.

FIG. 12 illustrates a schematic view of the coupling of the disclosed connection assembly for the slim hole coupled connection having the multiple taper sections for the thread.

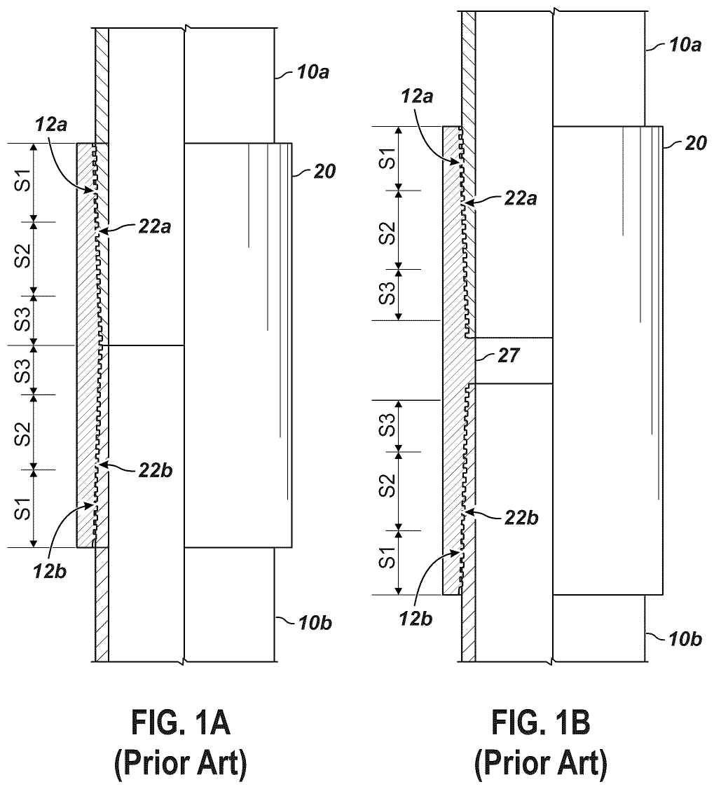

### DETAILED DESCRIPTION OF THE DISCLOSURE

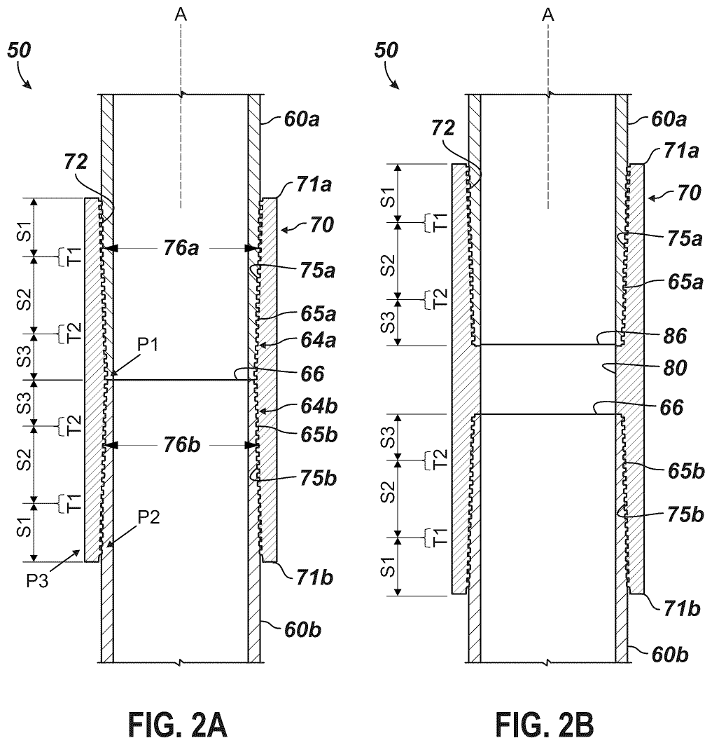

FIG. 2A illustrates a cross-sectional view of a connection assembly 50 according to the present disclosure. The connection assembly 50 is used in a system to join tubulars 60a-b together to make a casing string for downhole deployment. (References made herein to tubular, casing, or pipe apply equally to one another.) As shown, a portion of a casing or tubing string having two tubular sections 60a-b are interconnected with a coupling 70. The tubular sections 60a-b can be casing sections, pipe, tubing, or other tubular components. The coupling 70 can be a body or member that is a hollow cylindrical. The casing sections 60a-b have pins 64a-b defining external thread 65a-b, which mate with internal thread 75a-b of the coupling 70. The threaded pins 64a-b can contain standard American Petroleum Institute (API) Buttress Threads 65a-b with a constant taper. These threaded pins can also contain alternate API Threads, such as 8-round, or other industry-standard or proprietary thread forms. The faces or noses 66 of the two pins 64a-b can have square cut ends to furnish maximum bearing face when butted together at a center of the coupling 70.

Under standard practice, threads of a standard coupling would have an identical thread taper with the mating thread form (API Buttress Thread Form in this discussion) on the pin threads 65a-b so uniform radial thread interference can be produced through the full length of the thread profile. When the connection is assembled, this radial thread interference creates the contact pressure along the mating threadform interface that provides the desired sealing capabilities in the assembled connection.

As can be seen, the threads 65a-b on both the pins 64a-b and the threads 75a-b on the coupling 70 both taper, which results in variable cross-sections along the thread profile of each member. A thinner cross-section occurs at the faces or noses 66 of the pins 64a-b, associated with similar thinning cross-sections at the coupling's ends or bearing faces 71a-b. When the connection is assembled, the thinner cross-sections of the respective pin faces or noses 66 and coupling's ends 71a-b are opposite the heavier cross-sections of the mating member. The relative pin and coupling cross-sections at these locations therefore are imbalanced at the thinner ends of both members.

As expected, a uniform taper between the external threads 65a-b on the pins 64a-b and internal threads on a standard coupling would produce uniform interference along the thread profile. However, as pointed out above, the cross-sections of the mating members vary along the thread profile. Therefore, if the interference between the threads is uniform, but the cross-sections behind the threads are variable, then the resulting hoop stresses created in the cross-sections must also be variable, graduating from low stresses in the thicker part of the cross-sections in each member to high stresses in the thinner part. Indeed, Finite Element Analysis (FEA) shows that, after assembly, the hoop stresses in the thinner cross-sections of both the pins 64a-b and a standard coupling can approach and, with certain wall thicknesses of pins 64a-b, exceed the yield strength of the material used (e.g., steel). In addition to the negative impact of exceeding the yield strength in the thinner portions of the mating members, this differential yielding at the thin vs. thick cross-sections also causes differential movement between the threads at these same high stress points. This differential movement, at the high stress points, in turn results in thread galling in both the standard coupling threads 75a-b and the pins 64a-b particularly at the taper transition points T1 and T2. It is also anticipated that these same high stressed areas, particularly at the run-out threads at P2 of the pins 64a-b, can result in fatigue failure when the standard couplings are used in the drilling with casing or with rotating operations employed for target achievement when deploying casing in long lateral well sections.

In the cross-section shown, a shortened API Buttress Threaded coupling 70 connects two Buttress Threaded pins 64a-b that abut at the center of the coupling 70. This shortened and multiple tapered coupling 70 is designed to: (1) moderate concentrated mating thread interface bearing loads that cause high stresses previously outlined, (ii) reduce thread galling in areas of high stress, (ii) maintain compatibility with standard API Buttress threaded pins 64a-b, and (4) create a high torque connection by butting the pins faces or noses 66 at the center of the coupling 70.

To accomplish these objectives, the internal thread of the coupling 70 has varied or modified tapering at the areas of high stress (i.e., the areas of cross-sectional imbalances at coupling ends 71a-b and at pin faces or noses 66). In particular, the internal thread 75a-b in coupling 70 is segmented into sections (S1, S2, S3). When the connection is assembled, the imbalance between the noted cross-sections and any resulting excessive hoop stresses in the thinner cross-sections can be addressed using the varying taper sections (S1, S2, S3) for the internal threads 75a-b of the coupling 70.

Accordingly, the connection assembly 50 for joining the casing sections 60a-b includes the coupling 70, which can be a cylindrical body or member, having a first (field) end 71a and a second (mill) end 71b and defining a bore 72 therethrough. At least a first portion of the bore 72 defines a first continuous internal thread 75a, which has a first section (S1), a first transition (T1), a second section (S2), a second transition (T2), and a third section (S3). The first section (S1) is disposed at the first (field) end 71a, the second section (S2) is connected with the first section (S1) by the first transition (T1), and the third section (S3) is connected with the second section (S2) by the second transition (T2). Furthermore, a second portion of the bore (72) can also define a second continuous internal thread 75b mirroring the first continuous internal thread 75a.

The internal diameter 76a-b of the continuous internal threads 75a-b varies along the axial length of the coupling 70 so the sections (S1, S2, S3) have different tapers for the internal threads 75a-b from one section to the next. In particular, the taper in the second section (S2) can be maintained at the API standard taper to directly match the single taper machined on pin threads 64a-b. The matching pin and coupling tapers in S2 take advantage of the relative balance of the coupling and pin cross-sections. However, the taper in the first section (S1) can be greater than the taper in the second section (S2), and the taper in the second section (S2) can be greater than the taper in third section (S3). The varied tapers of the internal thread 75a-b in the coupling 70 relative to the uniform tapers of the external thread 65a-b on the pins 64a-b directly reduce the bearing loads imparted by the coupling thread crests on the pin thread roots in the mating thread elements in areas of the connection with unbalanced cross-sections in sections S1 and S3 (i.e., starting at points T1 and T2 at the transitions and varying along each section (S1 and S3) on the pins to the ends at P1 and to the coupling's ends 71a-b at P2). Employing multiple taper sections (S1, S2, S3) reduces the contact pressure in high areas of localized stress for sections (S1) and (S3) and thus mitigates problems of high stress, thread galling, and fatigue failure.

In one configuration, the internal thread 75a-b on each end of a 7-inch API Buttress Threaded coupling 70 is divided into three sections (S1, S2, S3) as previously described. The lengths and tapers for each section (S1, S2, S3) can be given for one particular casing OD and pipe wall thickness combination are as follows:

| Section | Length (in) | Taper (in/in) |
|---|---|---|
| S1 | 1.784 | 0.07525 |
| S2 | 1.716 | 0.06250 |
| S3 | 1.125 | 0.05556 |

The coupling 70 can be shortened (e.g., by approximately ¾ inch in some configurations) by removing what is commonly known as the “J” area between the two pins 64a-b in standard API Buttress Connections manufactured in accordance with API Specifications as enumerated in API Specifications 5CT and 5B. Eliminating the “J” area allows the faces or nose 66 of the two pins 64a-b to butt one another at the coupling's center when assembled to the power tight position, thereby providing high torque resistance needed for drilling with casing or casing rotating operations employed during casing deployment.

FIG. 2B illustrates a cross-sectional view of another connection assembly 50 according to the present disclosure joining two tubulars (casing sections) 60a-b together. The coupling 70 has an internal reinforcing cross-section or ring 80 at the center or opposite the “J” area. In this connection assembly 50, the face or nose 66 of each pin 64a-b abuts an internal square shoulder 86 at the heavy cross-section or ring 80, thereby providing high torque resistance needed for drilling with casing or casing rotating operation employed during casing deployment. The coupling 70 can be machined from a single piece of steel (i.e., coupling stock).

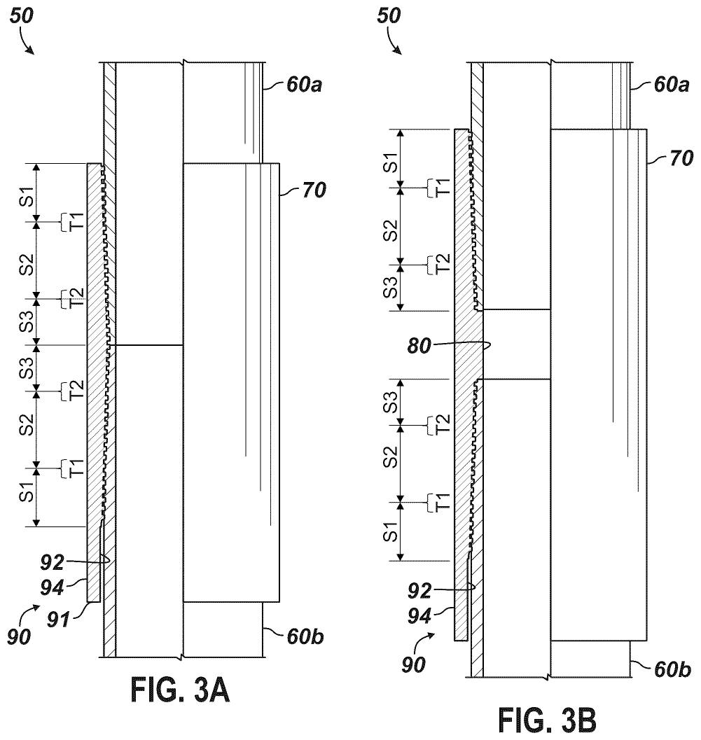

FIG. 3A illustrates a side view, in partial cross-section, of the connection assembly 50 of FIG. 2A, further including an optional unthreaded extension 90. The coupling 70 can include the optional unthreaded extension 90 integrally machined on one (mill) end 71b of the coupling 70. The extension 90 can provide a sacrificial wear sleeve to protect the main body of the coupling 70 as the casing is rotated down the wellbore in an abrasive environment. The wear extension 90 would have the same outside diameter as the coupling 70 with the inside diameter being slightly larger than the casing sections 60b so as to slip over the casing section 60b when the connection is assembled. As an option, the wear extension 90 can be hard banded if excessive abrasion is anticipated.

The inside diameter 92 of the wear extension 90 can be uniform from the face 91 for a specific distance toward the center of the coupling 70. The inside diameter 92 can then be tapered outward relative to the outside diameter of the coupling 70. This permits a threading tool to cut perfect (full formed) thread (e.g., 75b) over the entire coupling thread length without cutting into the inside diameter of the sacrificial wear extension 90. Elimination of machine marks in the inside diameter of the wear extension 90 near the coupling's internal threads 75b reduces the possibility of fatigue failures in the sacrificial wear extension 90.

FIG. 3B illustrates a side view in partial cross-section view of the coupling 70 of FIG. 2B, also including an optional unthreaded extension 90. Again, the optional unthreaded extension 90 can be integrally machined on one (mill) end 71b of the coupling 70. The extension 90 provides a sacrificial wear sleeve to protect the main body of the coupling 70 as the casing is rotated down the wellbore. The wear extension 90 can have the same outside diameter 94 as the coupling 70, and the inside diameter 92 can be slightly larger than the casing section 60b so as to slip over the casing section 60b when the connection is assembled. As an option, the wear extension 90 can be hard banded on part of its external surface should excessive abrasion be anticipated.

As before, the inside diameter 92 of the wear extension 90 can be uniform from the face 91 for a specific distance toward the center of the coupling 70, then can tapered outward relative to the outside diameter of the coupling 70. This permits a threading tool to cut perfect (full formed) thread (e.g., 75b) over the entire coupling thread length without cutting into the inside dimension of the sacrificial wear extension 90. Elimination of machine marks in the wear extension 90 near the coupling threads reduces the possibility of fatigue failures in the sacrificial wear extension 90.

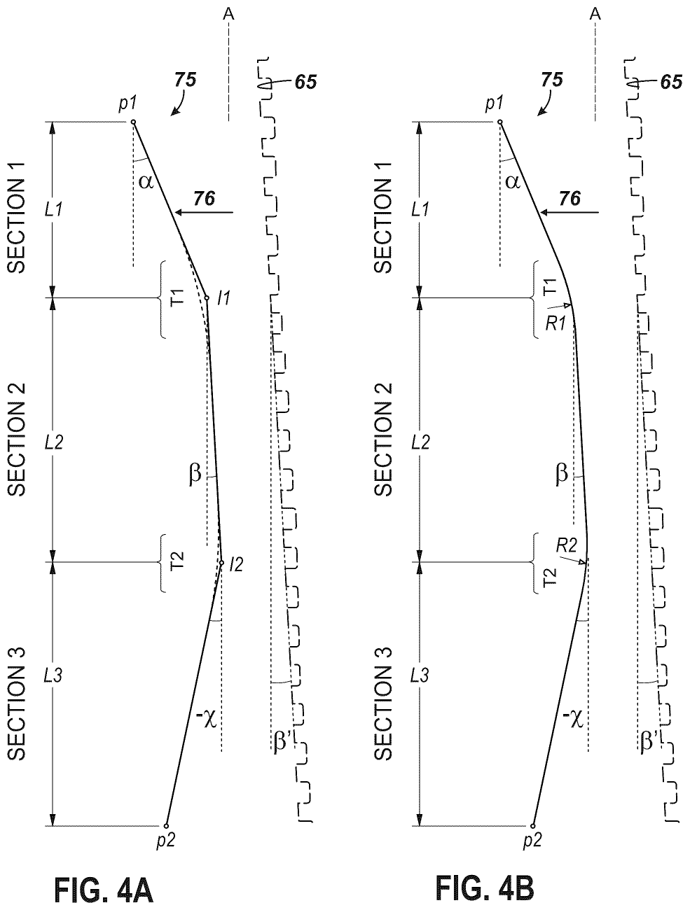

Having an understanding of the connection assembly 50 of the present disclosure, discussion turns to additional details about the continuous internal thread of the coupling 70. FIG. 4A illustrates a schematic of continuous internal thread 75 having three sections (S1, S2, S3) according to the present disclosure. FIG. 4B illustrates another schematic of the continuous internal thread 75 having curvatures at the transitions (T1, T2) between the sections (S1, S2, S3) according to the present disclosure.

In these schematics, an internal diameter 76 mid-way between the thread roots and crests of the continuous internal thread 75 is shown varying along the axial length so the sections (S1, S2, S3) have different tapers for the internal thread 75 from one section to the next. For simplicity, the profile of the threading for the continuous internal thread 75 is not shown. For comparative purposes, the profile and taper of external thread 65 for a pin of a casing section is illustrated to the side of the contour of the continuous internal thread 75. (It should be noted that the tapers in FIGS. 4A and 4B are greatly exaggerated relative to the external thread tapers of pin thread 65 for illustrative purposes. Additionally, it will be understood that the 2-Dimensional depictions shown here in FIGS. 4A-4B as well as in any other drawings are simply a convenient way to depict the complicated 3-Dimensional geometry of the present disclosure. The transition curves between sections of the thread are actually machined on a helix, which is only partially depicted in FIGS. 7A-7B.)

In the contour of the continuous internal thread 75, the internal diameter 76 for the first section (S1) converges linearly inward (i.e., toward the axial centerline A in the coupling's bore) at a first angle or taper (α) from a first point (p1) to the first transition (T1). The internal diameter 76 for the second section (S2) converges linearly inward at a second angle or taper (β) from the first transition (T1) to the second transition (T2). This second angle (β) is less than the first angle (α). The internal diameter 76 for the third section (S3) diverges linearly outward (i.e., away from the axial centerline A in the coupling's bore) at a third angle or taper (−χ) from the second transition (T2) to a second point (p2). (Because the third angle is diverging, it is labelled as a negative angle (−χ) in the discussion).

In contrast to the continuous internal thread 75, the external threads 65 for the pin of the casing section may be made to standard API Buttress specifications without modifications to length or taper. This external thread 65 is schematically illustrated to the side of the continuous internal thread 75. As noted, the continuous internal thread 75 is configured to thread to a pin having a single taper angle (β′). Accordingly, at least one of the first angle (α), the second angle (β), and the third angle (−χ) of the continuous internal thread 75 is approximate to the single taper angle (β′) of the pin thread 65. In particular, the second angle (β) of the second section (S2) can be approximate (i.e., should be matched within acceptable machining tolerances) to the single taper angle (β′) of the external thread 65 on the pin (64). In addition, the third angle (−χ) diverging outward can reduce galling and can reduce the chances of radial buckling in some instances when the pin (64) is threaded in the coupling (70) because the coupling (70) at the third section (S3) has its thickest wall whereas the pin (64) would be at its thinnest. Moreover, the third angle (−χ) diverges outward to reduce the thread interference, which can actually bring the thread interference comparable to that in standard API connections using the same thread form.

The taper angles (α, β, −χ) defined for the sections (S1, S2, S3) can be linear because the more linear sections (S1, S2, S3) can maximize the lengths (L1, L2, L3) of the sections (S1, S2, S3), and especially the second section (S2) that has the same taper on both members, thereby maximizing sealing integrity. The section lengths (L1, L2, L3) and the taper angles (α, β, −χ) employed can be designed to reduce contact pressure in areas of the connection where cross-sections are imbalanced. As will be appreciated, the actual lengths (L1, L2, L3) and taper angles (α, β, −χ) for the sections (S1, S2, S3) can depend on the constraints (relative coupling and pin wall thicknesses and diameters) of a particular implementation.

Instead of an angular change (angle) at the intersection (I1, I2) between the tapers of the sections (S1, S2, S3), the first and second transitions (T1, T2) each define a curvature that transitions from one taper section to the next. (Although both transitions (T1, T2) have curvatures, only one of them may have a curvature in another configuration).

A shown in detail in FIG. 4B, for example, the internal diameter 76 of the continuous internal thread 75a for the first transition (T1) defines a first curvature transitioning from the first angle (α) to the second angle (β), and the internal diameter 76 of the continuous internal thread 75 for the second transition (T2) defines a second curvature transitioning from the second angle (β) to the third angle (−χ).

Each of the transitions (T1, T2) can be a curved, tangential transition. For example, the first angle (α) and the second angle (β) are tangential to the first curvature of the first transition (T1); and the second angle (β) and the third angle (−χ) are tangential to the second curvature of the second transition (T2). These curved transitions (T1, T2) can further minimize the possibility of thread galling and yield significantly increased connection fatigue resistance by reducing the normal force (or bearing load) imparted between the coupling thread crests and pin thread roots at the transitions T1 and T2 during assembly of the connection improving on the features in the prior art. Moreover, the arrangement having the curved transitions (T1, T2) effectively converts a point load to a load distributed over a defined length.

Manufacture of the continuous internal thread 74 having the taper sections (S1, S2, S3) and the curved transitions (T1, T2) can be implemented using a threading program of a Computer Numerical Control (CNC) machine used for manufacturing couplings and threaded connections.

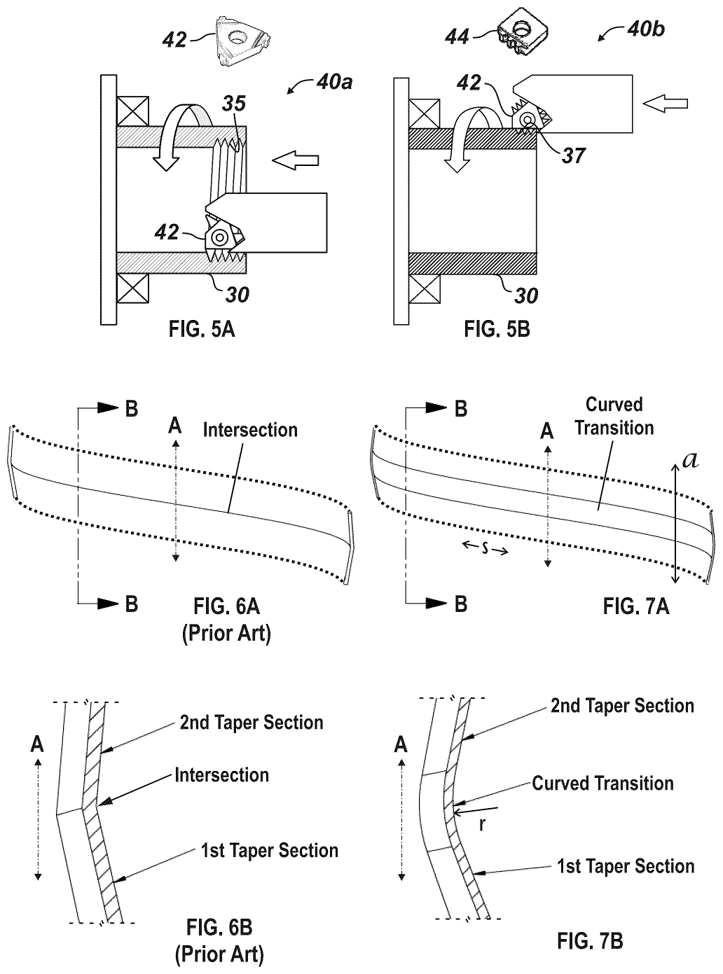

In general, forming the taper of threads is set by the type of threading tool used. Two types of tooling for threading tools are commonly available today. FIG. 5A schematically illustrates a first type of tooling 40a for making a thread form. This first type of tooling 40a is used for machining internal thread 35 on a component 30. The threading or cutting tool 42 has a single thread form on each corner that can cut the internal thread 35 of the component 30 along a programmed path that axially advances the tool 42 against the rotating component 30 along the thread length while changes to the radius (internal diameter) are made that removes material to form the finished threads. The final, machined threads are formed after multiple threading passes of the tool 42 during manufacturing. As shown, the cutting tool 42 can be triangular with three corners. As the cutting tool 42 wears, it is turned to use another corner until all corners are worn out.

FIG. 5B schematically illustrates a second type of tooling 40b, which is used for making an external thread 37 on a component 30. In this second type of tooling 40b, the threading or cutting tool 44 has three or more, co-linear thread forms causing varying depths of cuts to form the desired thread form for the external thread 37. This second type of tooling 40b requires fewer passes to cut the external thread 37 along the specified length.

In the prior art, such as in U.S. Pat. No. 7,347,459, the changes in internal thread taper were achieved with the first type of tooling by making small incremental changes in radius as the threading tool axially advances along the length. The incremental changes create a small step at the intersections (I1, I2) in individual finished threads in the variable taper sections (S1, S2, S3). These steps at the intersections (I1, I2) can be seen using an optical comparator at a 50× magnification. The prior art techniques have attempted to manage this process so these inherent steps in the thread caused by fixed tooling characteristics do not adversely impact the fit, form, or function of the mating threads.

In contrast to the prior art, the techniques of the present disclosure “soften” the inherent small steps from one tapered segment to another in the finished threads 75 by using the tangentially, curved transitions (T1, T2). The techniques of the present disclosure seek to improve the prior art by further reducing normal forces in areas prone to thread galling and fatigue failure initiated by deployment operations involving drilling with casing and/or reciprocating and rotating the casing either singularly or in combination to aid landing-target achievement for the casing in horizontal laterals.

Further details related to the prior art intersections and the curved transitions of the present disclosure are discussed with reference to FIG. 6A to FIG. 7B.

In particular, FIG. 6A schematically illustrates a representation of a helical profile for two tapered sections meeting at an intersection according to the prior art, and FIG. 6B schematically illustrates a cross-section of the representation of the helical profile in FIG. 6A. The threads of the thread form that would be defined along this helical profile are not shown, and the tapered sections that meet at the intersection of adjacent tapers would extend additional lengths in the axial direction A.

For comparison, FIG. 7A schematically illustrates a representation of a helical profile for two tapered sections meeting at a curved transition according to the present disclosure, and FIG. 7B schematically illustrates a cross-section of the representation of the helical profile in FIG. 7A. As will be appreciated, the features of a curved transition between tapered sections depicted in FIGS. 4A-4B have been illustrated with two-dimensional representations. When the curved transition between tapered sections is formed on a coupling as disclosed herein, however, it will be appreciated that the curved transitions between the tapered sections are made on a three-dimensional mechanical component. The teachings of the present disclosure overcome the complexity of this challenging process to produce smooth transitions from one threaded section to another within the helical thread.

Again, the threads of the thread form that would be defined along this helical profile are not shown, and the first taper section enters a curved transition tangential to the first taper which exits the curved transition that is tangential to the second taper. Whether entering or exiting the tangentially curved transition the respective tapers extend additional lengths in opposite axial directions A.

These schematic representations of the helical profiles in FIGS. 6A-6B and 7A-7B are enlarged to illustrate the difference between the prior and the disclosed configuration. While not presented to scale, the schematic representations are sized consistently for ready comparison. As noted, helical threads (not shown) would follow the helical profile. The change from one tapered section to another tapered section occurs over a small portion of the circumference of the interior threaded surface. In particular, the prior art transition as in FIGS. 6A-6B is formed over a much smaller portion of the interior threaded helical surface of the helical profile and may occur over about a quarter (¼) rotation of the threading tool. By contrast, the smooth curved transition of the present disclosure as in FIGS. 7A-7B spans a larger portion of the interior threaded helical surface of the helical profile and may have a span(s) over a half (½) turn to one (1) full rotation of the coupling 70 as the coupling 70 is threaded by the cutting tool used to form the features. In general, the span(s) of the helical profile is defined by (i) a relative thickness of the mating components (the coupling 70 and the tubular 60a-b) and (ii) the radius (r) of the curved transition.

The span of the disclosed curved transition over portion of the interior threaded surface's circumference can be configured for a given implementation. In general, the curved transition may have a greater span over more of the internal threads when implemented with oversized couplings and/or casing with heavy wall thickness. The delineation between what constitutes smaller and larger sizes in this context may occur at a pipe size with a wall thickness greater than about 0.550 inches.

As noted, the continuous internal thread 75 has curved transitions (T1, T2) that are tangent to the merging taper sections (S1, S2, S3). Considering that helical threads for the continuous internal thread 75 are machined into the coupling body that is a hollow cylinder, each of the curved, tangential transitions (T1, T2) presents a complicated 3-dimensional challenge for programming and machining. The lengths and radii (R1, R2) of the curved transitions (T1, T2) are preferably engineered to improve performance over existing thread arrangements known in the art. In particular, the axial length of each transition (T1, T2) is preferably configured to be within ±1 to 2 thread pitches on either side of the hypothetical intersections or points (I1, I2) between the meeting tapers (α, β, −χ). As defined, the thread pitch for the continuous internal thread 75 is the measurement of how far the continuous internal thread 75 advances axially in one complete turn about the cylindrical bore of the coupling so the thread pitch can be defined as the reciprocal of the number of threads per unit length. In one configuration, the axial length (a) that the helical profile extends can be between about ¼ to ½ of the thread pitch to about ½ to 1 of the thread pitch of the continuous internal thread 75. Again, the axial length (a) of the helical profile is defined by (i) a relative thickness of the mating components (the coupling 70 and the tubular 60a-b) and (ii) the radius (r) of the curved transition. Moreover, the radius (R1, R2) for each transition (T1, T2) is also configured so proper thread interference can be maintained for connection axial load and leak resistance.

In that sense, the continuous internal thread 75 can reduce local bearing loads between the coupling thread crests on the pin thread roots when the connection is fully assembled for improved galling resistance and significantly greater resistance to long-term, low-level cyclic loading. These improvements can give the coupling (70) improved fatigue life during service and can allow for substantially more rotating hours in difficult well conditions. The enhanced utility gives operators a considerably better chance of achieving target depths before fatigue failure when drilling with casing or rotating casing for target achievement in extended reach, horizontal laterals.

The coupling 70 is a complicated 3-dimensional component machined to have a continuous (helical) internal thread 75. In a 2-dimensional situation as depicted in FIG. 4A, the bearing force developed at the intersections (I1, I2) between sections (S1, S2, S3) occurs at a single point, which has no area, if the curved transitions (T1, T2) as disclosed herein are not present. This condition theoretically causes infinite stress due to the load at the single bearing points of the intersections (I1, I2). In the complicated 3-dimensional coupling 70 with a continuous (helical) internal thread 74, the area over the intersections (I1, I2) is quite small but does not occur at a single point as depicted in the 2-dimensional example. However, the actual bearing area over which assembly bearing forces attenuate is relatively small, and the localized bearing force of the coupling thread crest on the mating pin thread root causes localized high stress that contributes to thread galling and reduced fatigue life compared with the present invention.

The continuous internal thread 75 disclosed in FIG. 4B having the curved transitions (T1, T2) greatly reduces localized bearing stresses by spreading or attenuating localized bearing forces over a designed axial length, which is curved. This provides an improvement over the prior art and provides operators with increased rotating time before connection endurance limits may be exceeded.

The continuous internal thread 75 with the curved transitions (T1, T2) between taper sections (S1, S2, S3) as in FIG. 4B is expected to have little to no effect on costs while improving downhole utility through increased endurance limit of the connection in service. In practice, the coupling 70 manufactured with this continuous internal thread 75 is expected to exhibit no overt changes during assembly or use after downhole deployment. However, performance improvements relative to fatigue resistance and reduced galling can be significant.

As noted in the background of the present disclosure, for instance, new drilling technologies and advancements in drilling operations have allowed operators to drill wells with significantly longer lateral sections, which may exceed in some cases 22,000 ft (4 miles). The connection assembly (50) disclosed herein supports drilling these longer lateral sections. The connection assembly (50) disclosed herein can significantly improve the likelihood of successfully deploying casing to the intended target or surviving operations to free stuck pipe in difficult wellbore situations. This feature gives the operator greater utility to work the casing to achieve target depth and/or to free stuck pipe.

Analysis shows that the curved, tangential transitions (T1, T2) reduce localized normal forces between the mating box thread crest and pin thread root by 32% in the curved transitions (T1, T2) of the sections (S1, S2, S3) in one configuration (compared to just simple angled intersections of straight-line tapers as used in the prior art). This reduction in normal force yields significant reduction in stress reversal magnitudes caused by rotating casing, thereby increasing the endurance limit of the connection assembly (50) for significant increases in allowable rotating time. The actual increase in allowable rotating time (or endurance limit) of the connection assembly (50) is governed by the severity of the wellbore's dog leg, which defines the stress reversal range. However, in the present configuration used for this illustration in a typical wellbore trajectory, the operator can see an increase in allowable rotating hours of about 30%. In certain situations, this increased rotating time can allow the operator to complete an otherwise unsuccessful event well.

A secondary benefit of this refined feature is a significant reduction in thread galling potential. So, if a casing string can be recovered, the operator will likely be able to redeploy the casing string, i.e., can re-use all or most of the connection assemblies (50) after cleaning and re-prepping the borehole for rerunning the casing (assuming proper running and retrieval procedures are followed in accordance with manufacturer's instructions.)

The multiple tapers (α, β, −χ) for the sections (S1, S2, S3) in the coupling 70 reduce the bearing stresses and therefore reduce localized stress risers in the run-out pin threads where assembled connections commonly fail in fatigue under cyclic loading. The continuous internal thread 74 with the curved, tangential transitions (T1, T2) further reduces localized normal forces and therefore bearing stresses in the run-out pin threads developed during assembly of the connection (i.e., where assembled connections commonly fail in fatigue under cyclic loading).

The continuous internal thread 75 reduces localized normal forces and therefore bearing stresses by distributing bearing stresses axially over the curved length of the transitions (T1, T2). This configuration improves fatigue resistance through bearing load distribution over the length of the curved transitions (T1, T2) and the associated localized, lower bearing stresses distribution in the run-out pin threads (i.e., where assembled connections commonly fail in fatigue under cyclic loading). This continuous internal thread 75 also improves connection fatigue resistance providing longer fatigue life when drilling-with-casing or rotating casing to achieve downhole targets in restricted wellbore conditions.

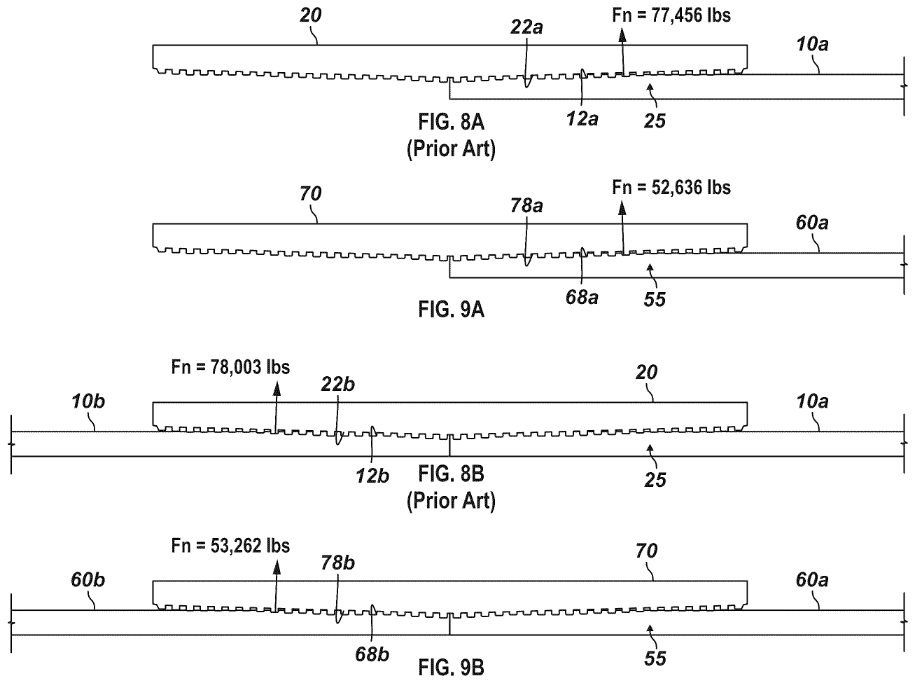

FIGS. 8A-8B and 9A-9B illustrate schematics based on Finite Element Analysis results from simulation of the disclosed connection assembly 50 in one configuration relative to the prior art. Computer models developed by Computer Assisted Drafting (CAD) software are analyzed using highly sophisticated Finite Element Analysis (FEA) software to produce calculations discussed here. This method is state-of-the-practice for determining various engineering attributes in structural components such as the connections discussed here.

In particular, FIG. 8A illustrates a schematic analysis of force during mill end makeup of a prior art coupling 20 to the “mill end” of a tubular 10a. This prior art coupling 20 is comparable to that discussed in the background of the present disclosure. By contrast, FIG. 9A illustrates a schematic analysis of force during mill end makeup of the disclosed coupling 70 to the “mill end” of a tubular 60a. As is known, the “mill end” makeup can involve threading the coupling to the “mill end” of a tubular to a hand-tight position in equipment that grips and holds the pipe while another component of the same equipment grips the coupling and applies torque turning the coupling until a specific make up position is achieved.

As can be seen in the example of FIG. 8A, the mill end make-up for the prior art coupling 20 produces a calculated normal force (Fn) at T1 (approximately 77,456 lbs). By contrast, the mill end make-up for the disclosed coupling 70 in FIG. 9A produces a lower calculated normal force (Fn) at T1 (approximately 52,636 lbs.) at the same location. The plotted forces show the normal force (Fn) developed on the Box Thread Crest at the center of the transition zone. The numerical values from the normal force (Fn) at this Box Thread Crest are shown for direct comparison. (The models are based on nominal geometry and clearly show significant improvement provided by the disclosed coupling 70 in FIG. 9A). Similar reductions in calculated normal force are also observed at T2 with the present disclosure.

Meanwhile, FIG. 8B illustrates a schematic analysis of force during field makeup of the “field end” of another tubular 10b to the prior art coupling 20, whereas FIG. 9B illustrates a schematic analysis of force during field makeup of the “field end” of another tubular (e.g., casing) 60b to the disclosed coupling 70. As is known, the “field end” makeup involves handling the casing and stabbing the field end into the open end of the coupling using a stabbing guide, making initial turns during the stabbing process using a chain tong or a power tong in low speed, and threading the “field end” of the tubular (e.g., casing) 60b in the coupling 70. It should be noted here that the mill end can be made up with the disclosed coupling 70 threaded a little past the coupling centerline, which creates more interference on that side of the threaded connection 55. This can help prevent the coupling 70 from turning during makeup of the field end at the rig.

In this makeup operation, the “lower” tubular 10a of the casing is held with slips in the rig floor's rotary table while casing tongs grip and turn the “upper” tubular 10b of the casing above the coupling 20 until a power-tight makeup is achieved. Typically, makeup RPMS are initially high (20 to 40 RPM) until the last two full turns, which are then completed in low gear at less than 10 RPMs. Significant torque is applied to produce pin nose engagement between the tubular sections 10a-b, followed by a small increment of axial advancement to lock up or energize the connection. A connection is energized when a significant compression force occurs due to the opposing pin engagement, which causes pre-tensioning about the centerline of the mating coupling 20. Energization of the coupling 20 is necessary to lock the connection for better resistance of anticipated downhole loads that may consist of axial (tension and compression), bending, and pressure (internal and external) occurring individually or in any combination. In addition, pin nose contact resists any additional axial advancement of the pin(s) into the coupling 20 that is associated with rotating operations that cause vibration, slip stick, variable friction along the casing string OD, and other factors.

As can be seen in the example of FIG. 8B, the field end makeup for the prior art coupling 20 produces a mating thread coupling crest to pin root calculated normal force (Fn) (approximately 78,003 lbs) at T1. By contrast, the field end makeup for the disclosed coupling 70 in FIG. 9B produces a lower calculated normal force (Fn) (approximately 53,262 lbs) at T1. Again, the plotted forces show the normal force (Fn) developed on the Box Thread Crest at the center of the transition zone. The numerical values from the normal force (Fn) at this Box Thread Crest are shown for direct comparison. (Again, the models are based on nominal geometry and clearly show significant improvement provided by the disclosed coupling 70 in FIG. 9B.) Similar reductions in calculated normal force are also observed at T2 with the present disclosure.

In previous examples, both of the curved transitions (T1, T2) have been applied at the intersections (I1, I2) between the sections (S1, S2, S3). The benefits of the present disclosure can be achieved when the disclosed curved transitions (T1, T2) have been applied at one or the other of the intersections (I1, I2) between the sections (S1, S2, S3).

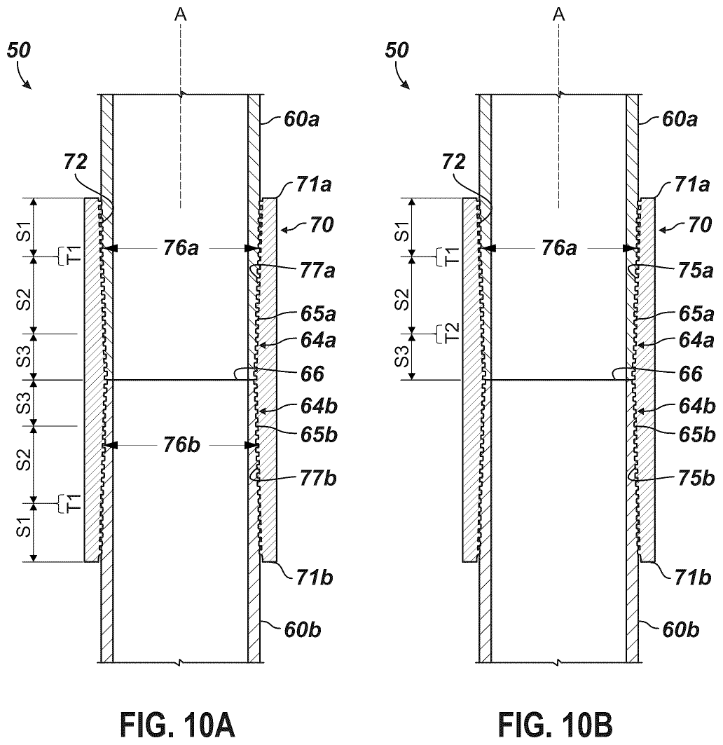

For example, FIG. 10A illustrates a cross-sectional view of another connection assembly 50 according to the present disclosure, joining two tubular sections 60a-b together. Details of the connection assembly 50 are similar to those discussed above so comparable reference numbers are used for comparable components, even though they may not be described again here. In contrast to previous arrangements, each continuous internal threads 77a-b has a first section (S1), a first transition (T1), a second section (S2), and a third section (S3). Thus, the curved transition (T1) disclosed herein is applied to the first intersection (I1) between the first and second sections (S1, S2), but not at the second intersection (I2) between the second and third sections (S2, S3). Instead, the second intersection (I2) between the second and third sections (S2, S3) may have a conventional intersection—e.g., an angle defined between the tapers of the sections (S2, S3). Alternately, in another configuration, the same taper may be used in sections S2 and S3, which eliminates the need for a second intersection I2. Consequently, the configuration would only have two taper sections S1, S2 with one intersection I1, thereby eliminating the third section S3.

Use of the disclosed curved transition (T1) only applied at the first intersection (I1) between the first and second sections (S1, S2) may be suitable for certain sizes, weights (wall thicknesses), and/or grades of the disclosed connection assembly 50. As an alternative, a disclosed curved transition (T2) may alternatively be applied only at the second intersection (I2) between the second and third sections (S2, S3), which may be suitable for other sizes, weights (wall thicknesses), and/or grades of the disclosed connection assembly 50. In any event, heavier wall casing may benefit from applying the disclosed curved transitions (T1, T2) between both of the adjacent sections (S1, S2 & S2, S3) as previously described.

Although the configuration of the coupling 70 may preferably be symmetrical, different combinations of one or both of the intersections (I1, I2) having the disclosed curved transitions (T1, T2) can be used in the bore 72 at the ends 71a-b of the coupling 70. For example, FIG. 10B illustrates a cross-sectional view of yet another connection assembly 50 according to the present disclosure, joining two tubular sections 60a-b together. Details of the connection assembly 50 are similar to those discussed above so that comparable reference numbers are used for comparable components, even though they may not be described again here. In contrast to previous arrangements, the first continuous internal thread 75a at the field end 71a of the coupling 70 may have the disclosed curved transitions (T1, T2) between the sections (S1, S2, S3) as described herein. However, internal thread 78b at the mill end 71b of the coupling 70 may have another type of thread, such as a conventional Buttress thread or a sectioned thread as described in the prior art of the background section of the present disclosure. A reverse arrangement is also possible in which the internal thread 75b at the mill end 71b has the disclosed curved transitions (T1, T2) between the sections (S1, S2, S3) as described herein while the internal thread 78a at the field end 71a has a conventional Buttress thread, a sectioned thread as described in the background section of the present disclosure, or another type of thread. This type of arrangement is commonly known in the industry as a cross-over.

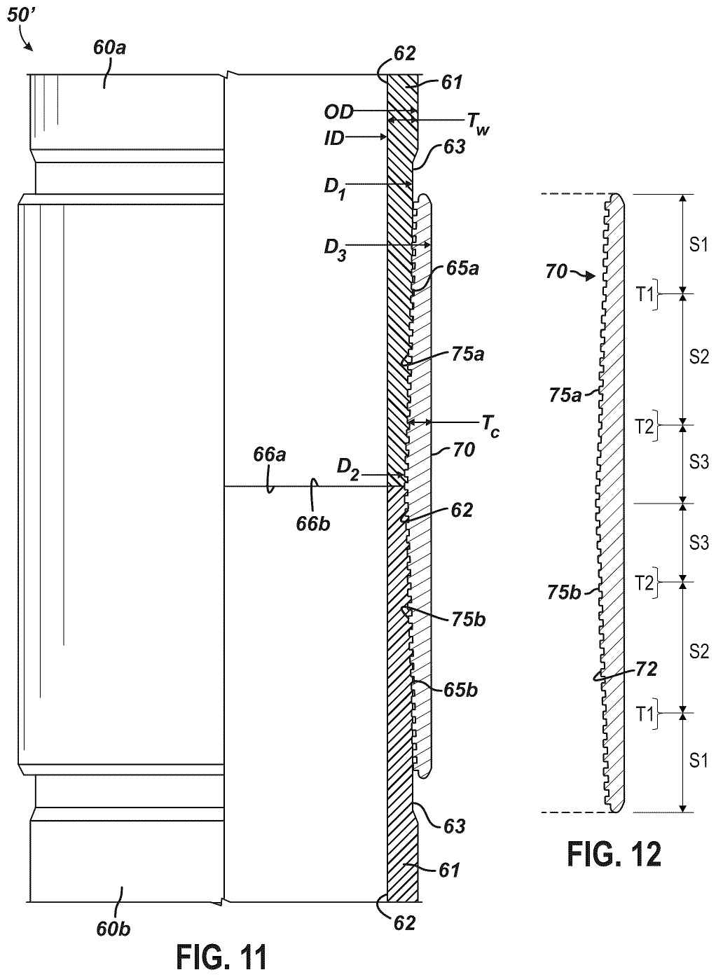

FIG. 11 illustrates a connection assembly 50′ for connecting casing tubulars 60a-b together with a coupling 70 in a slim hole coupled connection according to the present disclosure. The connection assembly 50′ disclosed herein can also be used in a slim hole coupled connection for a tight clearance situation between successive casing strings in a well or for a low clearance situation when a casing string is used within the actual wellbore. In contrast to the typical connections, however, the disclosed connection assembly 50′ uses the coupling 70 with a defined smaller than standard OD to connect the pins 64a-b of adjoining casing tubulars 60a-b together.

The casing tubulars 60a-b have pipe bodies 61 with an internal bore 62. The pipe bodies 61 generally have an outside diameter OD and an inside diameter ID that define a wall thickness T_{w} of the casing tubulars 60a-b. As is customary, the casing tubular 60a-b for the subject applications usually has standard sizes for downhole use with the outside diameters OD ranging from 4½ in. to 13⅝ in. Moreover, the casing tubular 60a-b usually has a particular weight (lbs/ft) defined by the wall thickness T_{w} suited to the implementation and its requirements. Some example casing sizes include 5½ in. and 7⅝ in. The weight for 5½ in. casing can range from 11.5 to 43.10 lbs/ft, whereas the weight for 7⅝ in. casing can range from 24.0 to 55.30 lbs/ft. The particular characteristics of casing are defined by American Petroleum Institute (API) casing specifications.

The pins 64a-b (having thread 65a-b) have an OD turndown 63 that is machined into the outer wall of the casing tubular's pipe body 61. The cylindrical turndown 63 has a reduced diameter D₁ less than the standard outside diameter OD of the casing tubular 60a-b. The turned-down 63 has a constant diameter initially machined along the entire length of the pin 64a-b. Pins 64a-b (having thread 65) are then threaded to a smaller diameter D₂ at the nose 66 with an increasing constant taper to the diameter of the turndown 63. Pin thread 65 is a run out thread machined to an extent that lies only partially along the turndown 63 to the nose 66 of the pin 64a-b.

The coupling 70 is a cylindrical body having an outer diameter D₃ and an inner bore 72. The coupling 70 has a wall thickness Tc defined by the outer diameter D₃ and an inner diameter of the coupling's inner bore 72. The inner bore 72 is threaded with a tapered box thread 75a-b to connect to complimentary tapered pin threads 65a-b on the turned-down pins 64a-b of the adjoining casing tubulars 60a-b. The box thread of continuous internal thread 75a-b has opposing box thread sections along the length of the coupling 70. In particular, one box thread section of continuous internal thread 75a generally tapers outward from a center of the coupling's bore 72 to one of the opposing ends, and the other box thread section 75b generally tapers outward from the center of the coupling's bore 72 to the other of the opposing ends. Thus, the wall thickness Tc of the coupling 70 constantly varies toward both ends of the coupling 70.

The threads 75a-b of the coupling 70 have multiple taper sections, such as disclosed above. For example, FIG. 12 illustrates a schematic view of the coupling 70 for the disclosed slim hole coupled connection including multiple taper sections S1, S2, S3 and including one or more curved transitions T1, T2 for the thread 75a-b. Three sections are simply shown as an example, and more or fewer sections can be used. The multiple taper sections S1, S2, S3 can reduce contact pressure in areas of the connection assembly 50′, can provide better resistance to long-term, low-level fatigue loading that occurs while rotating casing, and can reduce thread galling common when assembling high interference threaded connections.

As noted above, the curved transitions T1, T2 can be curved, tangential transitions defined between the tapered sections S1, S2, S3. These curved transitions T1, T2 can further minimize the possibility of thread galling and yield significantly increasing connection fatigue resistance by reducing the normal force (or bearing load) imparted between the coupling thread crests and pin thread roots at the transitions T1 and T2 during assembly of the connection improving on the features in the prior art. Moreover, the arrangement having the curved transitions (T1, T2) effectively converts a point load to a load distributed over a defined length, greatly reducing the applied bearing pressure at the mating interface. The curved transitions (T1, T2) can provide these and other benefits noted above.

Returning to FIG. 11, the pin threads 65a-b thread respectively in the box threads 75a-b at the ends of the coupling 70 to make up the slim hole connection assembly 50′. The bearing surfaces on the noses 66 of the pins 64a-b engage with one another inside the coupling 70. FIG. 11 illustrates the connection assembly 50′ made-up under full power-tight assembly. With power-tight assembly, the bearing faces on the noses 66a-b of the pins 65a-b meet in the center of the coupling 70 and develop high contact pressure at the mating interface. Features of this connection assembly 50′ can be configured to optimize pressure efficiency, tension efficiency, and torque resistance, such as disclosed in co-pending U.S. application Ser. No. 17/840,018 filed Jun. 14, 2022, which is incorporated herein by reference in its entirety.

Configurations of the present disclosure can be characterized by the following clauses:

1. A coupling for joining tubulars, the coupling comprising:
a body (70) having a first end (71a) and a second end (71b) and defining a bore (72) therethrough;
at least a first portion of the bore (72) defining a first continuous internal thread (75a), the first continuous internal thread (75a) having a first section (S1), a second section (S2), and a third section (S3), the first section (S1) disposed at the first end (71a), the second section (S2) connected with the first section (S1) at a first intersection (I1), the third section (S3) connected with the second section (S2) at a second intersection (I2),
an internal diameter (76a) of the first continuous internal thread (75a) for the first section (S1) converging linearly inward toward the bore (72) at a first angle (α) from a first point (p1) to the first intersection (I1), the internal diameter (76a) for the second section (S2) converging linearly inward toward the bore (72) at a second angle (β) from the first intersection (I1) to the second intersection (I2), the second angle (β) being less than the first angle (α), the internal diameter (76a) for the third section (S3) diverging linearly outward from the bore (72) at a third angle (−χ) from the second intersection (I2) to a second point (p2),
wherein the internal diameter of the first continuous internal thread (75a) defines at least one of: (i) a first curvature (T1) transitioning between the first and second angles (α, β) at the first intersection (I1) of the first and second sections (S1, S2), and (ii) a second curvature (T2) transitioning between the second and third angles (β, −χ) at the second intersection (I2) of the second and third sections (S2, S3).

For example, the internal diameter (76a) of the first continuous internal thread (75a) at at least one of (i) the first intersection (I1) and (ii) the second intersection (I2) can define a tangential curvature entering and exiting transitions from a respective one of: (i) the first angle (α) to the second angle (β), and (ii) the second angle (β) to the third angle (−χ).

2. The coupling of clause 1, wherein the respective at least one of: (i) the first curvature (T1) is tangential to the first and second angles (α, β); and (ii) the second curvature (T2) is tangential to the second and third angles (β, −χ). In other words, for example, the respective one of (i) the first angle (α) and the second angle (β) and (ii) the second angle (β) and the third angle (−χ) are tangential to the curvature.

3. The coupling of clause 1 or 2, wherein:
the internal diameter (76a) defines the first curvature (T1) at the first intersection (I1);
the internal diameter (76a) for the first section (S1) converging linearly inward toward the bore (72) at the first angle (α) from the first point (p1) to the first curvature (T1); the internal diameter (76a) for the second section (S2) converging linearly inward toward the bore (72) at the second angle (β) from the first curvature (T1) to the second intersection (I2); and
the first curvature (T1) is tangential to the first angle (α) to the second angle (β).

4. The coupling of clause 1, 2 or 3, wherein:
the internal diameter (76a) defines the second curvature (T2) at the second intersection (I2);
the internal diameter (76a) for the second section (S2) converging linearly inward toward the bore (72) at the second angle (β) from the first intersection (I1) to the second curvature (T2); the internal diameter (76a) for the third section (S3) diverging linearly outward from the bore (72) at the third angle (−χ) from the second curvature (T2) to the second point; and
the second curvature (T2) is tangential to the second angle (β) to the third angle (−χ).

5. The coupling of clause 4, wherein the first curvature (T1) is tangential to the first angle (α) and the second angle (β); and wherein the second curvature (T2) is tangential to the second angle (β) and the third angle (−χ).

6. The coupling of any one of clauses 1 to 5, wherein the first continuous internal thread (75a) is configured to mate with a pin (64a) of one of the tubulars (60a); and wherein:
the pin (64a) having an external buttress-type thread (65a); or
the pin (64a) having a pin thread (65a) with a single taper angle (β′), and at least one of the first angle (α), the second angle (β), and the third angle (−χ) of the first continuous internal thread (75a) is approximate (i.e., matches within machining tolerances) to the single taper angle (β′) of the pin thread (65a), optionally wherein the second angle (β) of the second section (S2) is approximate (i.e., matches within machining tolerances) to the single taper angle (β′) of the pin thread (65a) on the pin (64a) of the tubular (60a).

7. The coupling of any one of clauses 1 to 9, wherein the at least one of the first and second curvatures (T1, T2) spans a helical profile around a portion of the respective continuous internal thread where one of the sections transitions to the adjacent section.

8. The coupling of clause 7, wherein:
the helical profile, of the first continuous internal thread (75a) being formed by a threading tool, spans between a half (½) rotation to one (1) full rotation of the coupling as the coupling is threaded by the threading tool;
the first continuous internal thread (75a) has a thread pitch, and an axial length (a) of the helical profile is between ¼ to ½ of the thread pitch to ½ to 1 of the thread pitch; or
an extent of the helical profile is defined by (i) a relative thickness of the body (70) and the tubular (60a-b) and (ii) radii of the first and second curvatures (T1, T2).

For example, the at least one of the first and second curvatures (T1, T2) spans a helical profile around a portion of the respective continuous internal thread between (i) a half (½) rotation of the coupling as the coupling is threaded by a threading tool (or an axial length of ¼ to ½ of the thread pitch) and (ii) one (1) full rotation of the coupling as the coupling is threaded by a threading tool (or an axial length of ½ to 1 of the thread pitch) depending on a relative thickness of the coupling body and the tubulars and depending on the radius of the curved transitions.

9. The coupling of any one of clauses 1 to 8, wherein at least a second portion of the bore (72) defines a second continuous internal thread (75b) mirroring the first continuous internal thread (75a).

10. The coupling of clause 9, wherein:
the first and second continuous internal threads (75a-b) meet at a center of the bore (72), whereby faces (66) on pins (64a-b) of the tubulars (60a-b) are configured to maximize pin nose bearing faces that abut one another to maximize connection torque resistance; or
the bore (72) defines a reinforced area (80) disposed between the first and second continuous internal threads (75a-b), the reinforced area (80) having shoulders (84) configured to abut faces (66) on pins (64a-b) configured to maximize pin nose bearing faces (for maximum torque resistance) of tubulars (60a-b) joined by the coupling.

11. The coupling of any one of clauses 1 to 10, wherein one end (71b) of the body (70) comprises a wear sleeve (90) extending therefrom, the wear sleeve (90) having an inner wall diameter (92) and an outer wall diameter (94); and wherein a first length of the inner wall diameter (92) of the wear sleeve (90) is cylindrical, and a second length of the inner wall diameter (92) tapers outwardly in a direction away from the bore (72) of the body (70).

12. A tubular system, comprising:
a plurality of tubulars (60), each having pins (64) disposed on ends of the tubular (60), the pins (64) having external thread (65);
a plurality of couplings (70) according to any one of clauses 1 to 11 and being configured to join the tubulars (60) together.

13. A method of manufacturing a tubular system for use downhole, the method comprising:
fabricating tubulars having pins at pipe ends;
fabricating couplings having first and second ends and defining a bore therethrough; and
forming a first continuous internal thread with an internal diameter in at least a first portion of the bore toward the first end of the couplings by:
converging the internal diameter, for a first section of the first continuous internal thread disposed toward the first end, linearly inward toward the bore at a first angle from a first point to a first intersection;
converging the internal diameter, for a second section of the first continuous internal thread connected with the first section at the first intersection, linearly inward toward the bore at a second angle from the first intersection to a second intersection, the second angle being less than the first angle;
diverging the internal diameter, for a third section of the first continuous internal thread connected with the second section at the second intersection, linearly outward from the bore at a third angle from the second intersection to a second point; and
defining the internal diameter of the first continuous internal thread with at least one of: (i) a first curvature transitioning between the first and second angles at the first intersection of the first and second sections, and (ii) a second curvature transitioning between the second and third angles at the second intersection of the second and third sections.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A coupling for joining tubulars, the coupling comprising:
a body having a first end and a second end and defining a bore therethrough;
at least a first portion of the bore defining a first continuous internal thread, the first continuous internal thread having a first section, a second section, and a third section, the first section disposed toward the first end, the second section connected with the first section at a first intersection, the third section connected with the second section at a second intersection; and
an internal diameter of the first continuous internal thread for the first section converging linearly inward toward the bore at a first angle from a first point to the first intersection, the internal diameter for the second section converging linearly inward toward the bore at a second angle from the first intersection to the second intersection, the second angle being less than the first angle, the internal diameter for the third section diverging linearly outward from the bore at a third angle from the second intersection to a second point,
wherein the internal diameter of the first continuous internal thread defines at least one of:
(i) a first curvature transitioning between the first and second angles at the first intersection of the first and second sections, and
(ii) a second curvature transitioning between the second and third angles at the second intersection of the second and third sections.

2. The coupling of claim 1, wherein the respective at least one of:
(i) the first curvature is tangential to the first and second angles; and
(ii) the second curvature is tangential to the second and third angles.

3. The coupling of claim 1, wherein:
the internal diameter defines the first curvature at the first intersection;
the internal diameter for the first section converges linearly inward toward the bore at the first angle from the first point to the first curvature;
the internal diameter for the second section converges linearly inward toward the bore at the second angle from the first curvature to the second intersection; and
the first curvature is tangential to the first and second angles.

4. The coupling of claim 1, wherein:
the internal diameter defines the second curvature at the second intersection;
the internal diameter for the second section converges linearly inward toward the bore at the second angle from the first curvature to the second curvature;
the internal diameter for the third section diverges linearly outward from the bore at the third angle from the second curvature to the second point; and
the second curvature is tangential to the second and third angles.

5. The coupling of claim 4, wherein the first curvature is tangential to the first and second angles; and wherein the second curvature is tangential to the second and third angles.

6. The coupling of claim 1, wherein the first continuous internal thread is configured to thread to a pin of one of the tubulars; and wherein:
the pin having an external buttress-type thread; or
the pin having a pin thread with a single taper angle, and at least one of the first angle, the second angle, and the third angle of the first continuous internal thread is approximate to the single taper angle of the pin thread, optionally wherein the second angle of the second section is approximate to the single taper angle of the pin thread on the pin of the tubular.

7. The coupling of claim 1, wherein the at least one of the first and second curvatures spans a helical profile around the first continuous internal thread where one of the sections transitions to the adjacent section.

8. The coupling of claim 7, wherein:
the helical profile, of the first continuous internal thread being formed by a threading tool, spans between a half (½) rotation to one (1) full rotation of the coupling as the coupling is threaded by the threading tool;
the first continuous internal thread has a thread pitch, and an axial length of the helical profile is between ¼ to ½ of the thread pitch to ½ to 1 of the thread pitch; or
an extent of the helical profile is defined by (i) a relative thickness of the body and the tubulars and (ii) radii of the first and second curvatures.

9. The coupling of claim 1, wherein at least a second portion of the bore defines a second continuous internal thread mirroring the first continuous internal thread.

10. The coupling of claim 9, wherein:
the first and second continuous internal threads meet at a center of the bore, whereby faces on pins of the tubulars are configured to maximize connection torque resistance between the faces that abut one another; or
the bore defines a reinforced area disposed between the first and second continuous internal threads, the reinforced area having shoulders configured to abut faces on pins of the tubulars joined by the coupling, the faces abutting the shoulders being configured to maximize torque resistance.

11. The coupling of claim 1, wherein one end of the body comprises a wear sleeve extending therefrom, the wear sleeve having an inner wall diameter and an outer wall diameter; and wherein a first length of the inner wall diameter of the wear sleeve is cylindrical, and a second length of the inner wall diameter tapers outwardly in a direction away from the bore of the body.

12. A tubular system, comprising:
a plurality of tubulars, each of the tubulars having a pipe body with a first outer diameter and defining a first bore with an inner diameter, each of the tubulars having pins disposed on ends of the tubular, the pins having external thread; and
a plurality of couplings being configured to join the tubulars together, each of the couplings comprising a coupling body having opposing ends, having a second outer diameter, and defining a second bore therethrough, the second outer diameter of the couplings being greater than the first outer diameter of the pipe body,
the second bore defining continuous internal threads extending outward from a center of the second bore respectively to the opposing ends of the coupling body,
each of the continuous internal threads of the couplings being configured to thread in a connection to a respective one of the external threads of the pins,
each of the continuous internal threads having a first section, a second section, and a third section, the first section disposed toward one of the opposing ends, the second section connected with the first section at a first intersection, the third section connected with the second section at a second intersection,
an internal diameter of each of the continuous internal threads for the first section converging linearly inward toward the second bore at a first angle from a first point to the first intersection, the internal diameter for the second section converging linearly inward toward the second bore at a second angle from the first intersection to the second intersection, the second angle being less than the first angle, the internal diameter for the third section diverging linearly outward from the second bore at a third angle from the second intersection to a second point,
wherein the internal diameter of each of the continuous internal threads defines at least one of:
(i) a first curvature transitioning between the first and second angles at the first intersection of the first and second sections, and
(ii) a second curvature transitioning between the second and third angles at the second intersection of the second and third sections.

13. A method of manufacturing a tubular system for use downhole, the method comprising:
fabricating tubulars having pins at pipe ends;
fabricating couplings having first and second ends and defining a bore therethrough; and
forming a first continuous internal thread with an internal diameter in at least a first portion of the bore toward the first end of the couplings by:
converging the internal diameter, for a first section of the first continuous internal thread disposed toward the first end, linearly inward toward the bore at a first angle from a first point to a first intersection;
converging the internal diameter, for a second section of the first continuous internal thread connected with the first section at the first intersection, linearly inward toward the bore at a second angle from the first intersection to a second intersection, the second angle being less than the first angle;
diverging the internal diameter, for a third section of the first continuous internal thread connected with the second section at the second intersection, linearly outward from the bore at a third angle from the second intersection to a second point; and
defining the internal diameter of the first continuous internal thread with at least one of: (i) a first curvature transitioning between the first and second angles at the first intersection of the first and second sections, and (ii) a second curvature transitioning between the second and third angles at the second intersection of the second and third sections.

14. The method of claim 13, wherein defining the internal diameter comprises defining the internal diameter with at least one of:
(i) the first curvature tangential to the first and second angles; and
(ii) the second curvature tangential to the second and third angles.

15. The method of claim 13, wherein fabricating the tubulars having the pins at the pipe ends comprises:
forming an external buttress-type thread on the pins, the first continuous internal thread being configured to thread to the external buttress-type threads on the pins; or
forming pin thread with a single taper angle on the pins, and forming the first continuous internal thread by forming at least one of the first angle, the second angle, and the third angle of the first continuous internal thread approximate to the single taper angle of the pin thread.

16. The method of claim 13, wherein defining the internal diameter with the at least one of the first and second curvatures comprises spanning the at least one of the first and second curvatures along a helical profile of the first continuous internal thread.

17. The method of claim 16, wherein spanning the at least one of the first and second curvatures along the helical profile comprises:
spanning between a half (½) rotation to one (1) full rotation of the coupling as the coupling is threaded by a threading tool used to form the first continuous internal thread; or
defining an axial length of the helical profile between ¼ to ½ of a thread pitch to ½ to 1 of the thread pitch for the first continuous internal thread; or
spanning an extent of the helical profile defined by (i) a relative thickness of the coupling and the tubulars and (ii) radii of the first and second curvatures.

18. The method of claim 13, further comprises forming a second continuous internal thread with an internal diameter in a second portion of the bore toward the second end of the couplings such that the second continuous internal thread mirrors the first continuous internal thread.

19. The method of claim 18, wherein forming the first and second continuous internal threads comprises:
meeting the first and second continuous internal threads at a center of the bore, whereby faces on pins of the tubulars are configured to abut one another; or
defining a reinforced area between the first and second continuous internal threads, the reinforced area having shoulders configured to abut faces on pins of the tubulars joined by the coupling.
